(19) United States
(12) Patent Application Publication
(10) Pub. No.: US 2017/0008471 A1
(43) Pub. Date: Jan. 12, 2017

(54) Wheel Protective Cover

(71) Applicant: Jim Webb, Malvern, AR (US)

(72) Inventor: Jim Webb, Malvern, AR (US)

(21) Appl. No.: 14/795,913

(22) Filed: Jul. 10, 2015

(51) Int. Cl. B60R 19/00

(52) U.S. Cl. CPC B60R 19/00; B60R 2019/002

(57) ABSTRACT

A protective wheel cover that partially surrounds the front, side and rear of the wheels of a commercial vehicle in order to prevent the rubber of the enclosed wheels from being thrown in the event of a blowout while the commercial vehicle is moving.

### CROSS-REFERENCE TO RELATED APPLICATIONS

Not Applicable

### STATEMENT REGARDING FEDERALLY SPONSORED RESEARCH OR DEVELOPMENT

Not Applicable

Reference to Sequence Listing, a Table, or a Computer Program Listing Compact Disc

Not Applicable

### DESCRIPTION

Field of the Invention

This disclosure relates to a protective cover for rear-axle wheels for tractor trailers. The purpose is to surround the rear wheels with a cover to minimize the risk of harm to others in the event of a blowout.

Background of the Invention

When a blowout of a rear wheel for a commercial vehicle occurs while the commercial vehicle is moving, the rubber of the wheel gets thrown from the commercial vehicle, placing those around the commercial vehicle in harms way of impact, which could result in damage to other vehicles and individuals. The present disclosure encloses the rear wheels of the commercial vehicle so that, when a wheel does blow out, the rubber from the wheel is trapped in the enclosure, the enclosure absorbs the force of the thrown rubber, and the rubber is forced down to the ground, eliminating the risk from the thrown rubber.

### SUMMARY OF THE INVENTION

The present disclosure is a protective wheel cover that partially surrounds the front, outside and rear of the wheels of a commercial vehicle. In the first embodiment the wheel protective cover comprises an enclosure and an access hatch. In the second embodiment the wheel protective cover comprises an enclosure structure, a covering that goes onto the structure and an access hatch. The enclosure or enclosure structure are comprised of material of sufficient durability to absorb the impact of the thrown rubber from a blowout of the enclosed wheels. The purpose of the access hatch is to allow one to gain approach to the enclosed wheels and work on the axil assembly.

In either the first embodiment or the second embodiment, the wheel protective cover can be attached to the underside of the commercial vehicle or to the slider of the commercial vehicle, so that when the position of the wheels are adjusted, the position of the enclosure is adjusted as well.

### BRIEF DESCRIPTION OF THE SEVERAL VIEWS OF THE DRAWING

FIG. 1 is a view of the wheel protective cover as displayed on a commercial vehicle;

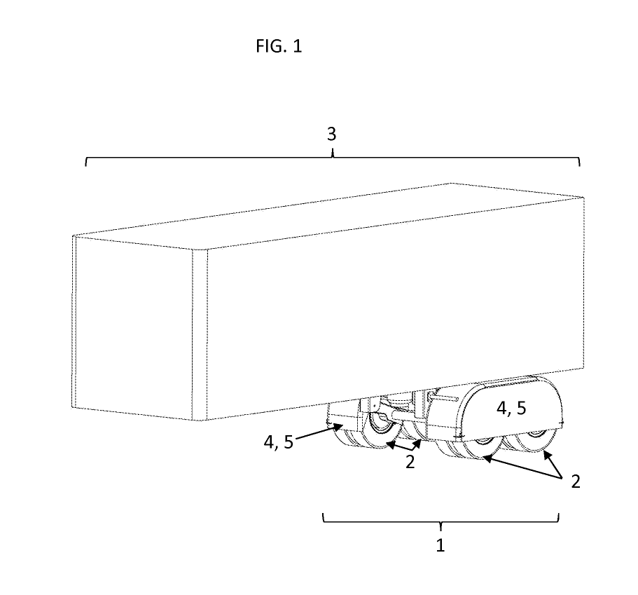

FIG. 2 is a view of the wheel protective cover as attached to the bottom of a commercial vehicle;

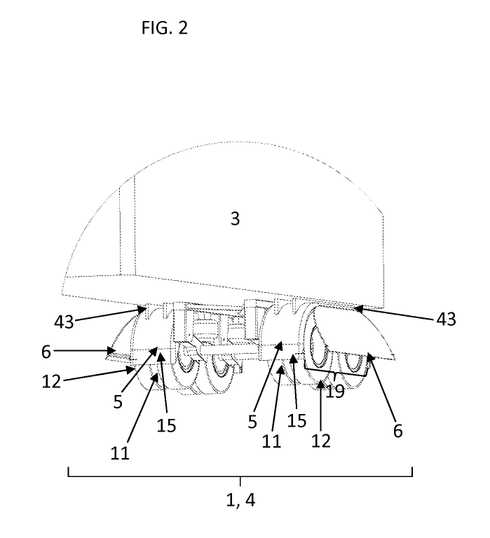

FIG. 3 is a view of the wheel protective cover as attached to the slider of a commercial vehicle;

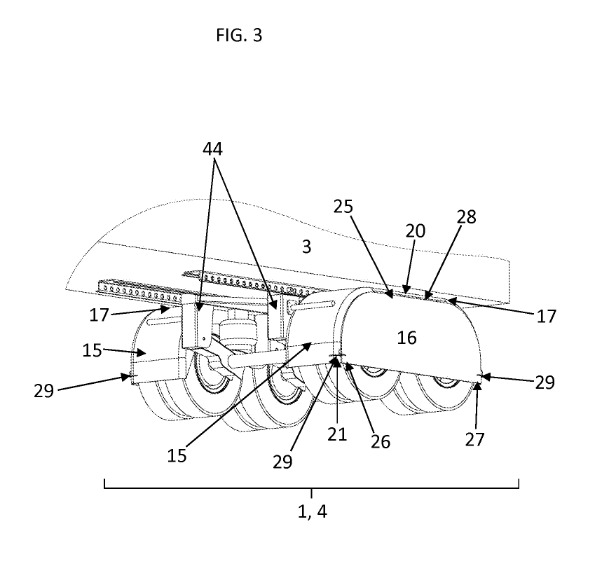

FIG. 4 is a view of the side of the first embodiment of the wheel protective cover including the hatch;

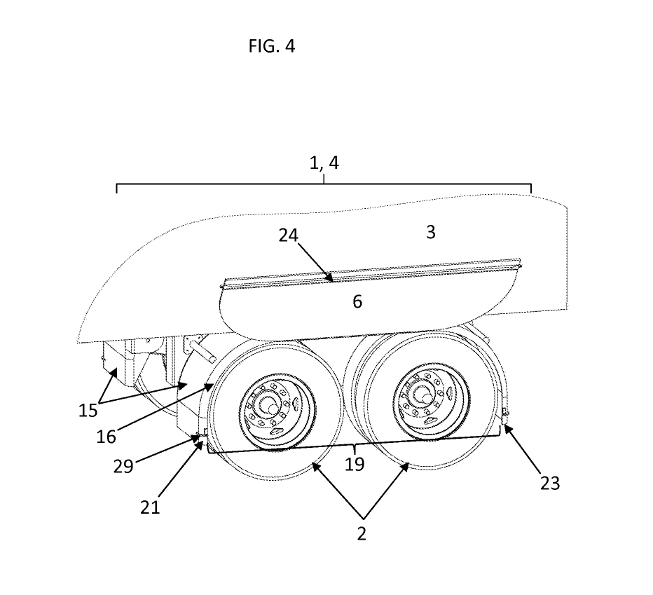

FIG. 5 is a view of the front of the first embodiment of the wheel protective cover;

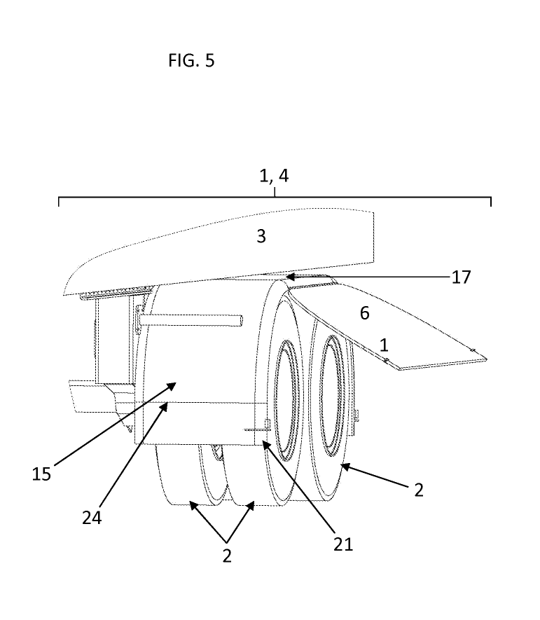

FIG. 6 is a view of the rear of the first embodiment of the wheel protective cover;

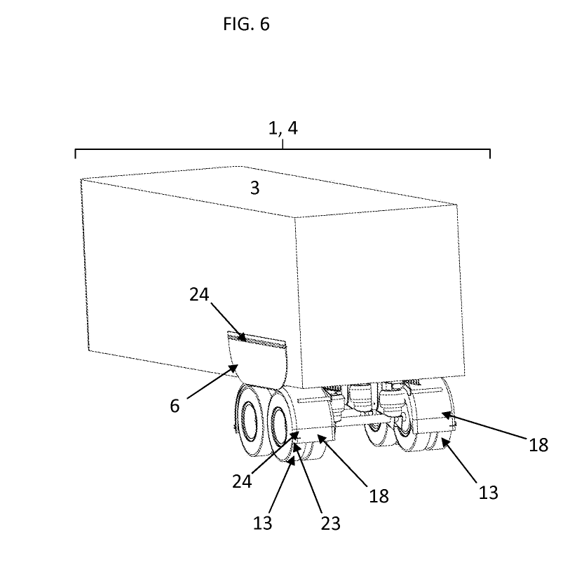

FIG. 7 is a side view of the enclosure structure of the second embodiment of the wheel protective cover;

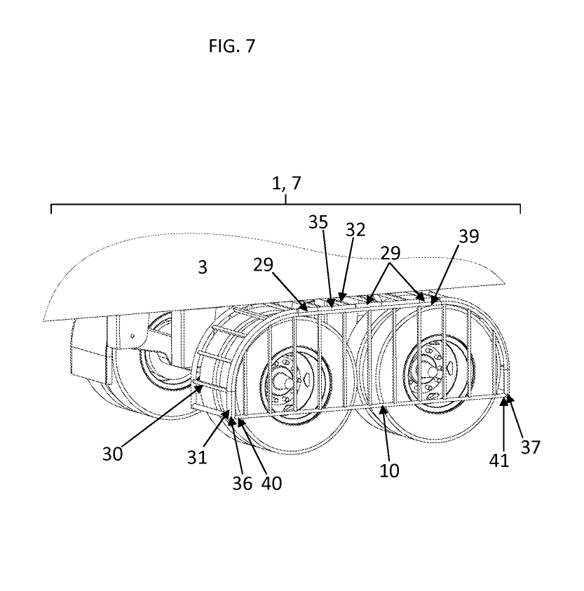

FIG. 8 is a front view of the enclosure structure of the second embodiment of the wheel protective cover with the covering, which is made of cable netting, sheet metal, fiberglass, rubber, aluminum, or durable plastic; and

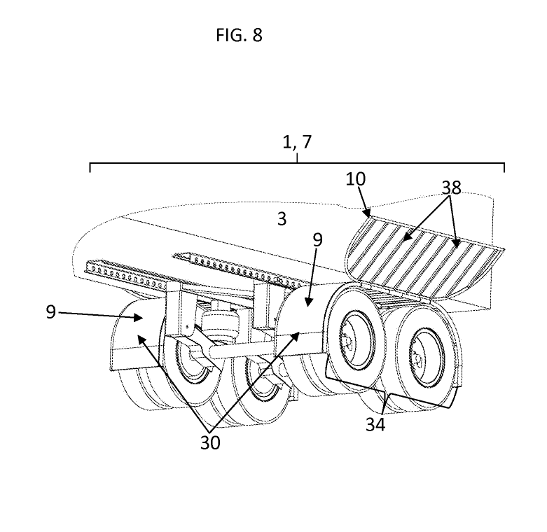

FIG. 9 is a rear view of the enclosure structure of the second embodiment of the wheel protective cover with the covering, which is made of cable netting, sheet metal, fiberglass, rubber, aluminum, or durable plastic.

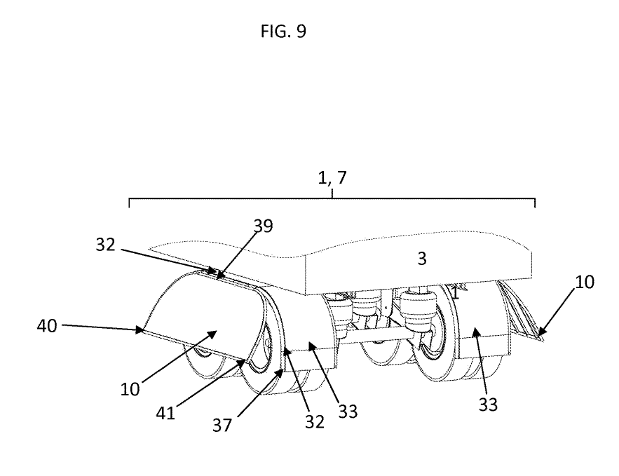

### DETAILED DESCRIPTION OF THE INVENTION

A wheel protective cover 1 to prevent the rubber of the wheels 2 from being thrown in the event of a blowout while the commercial vehicle 3 is moving with two embodiments. The first embodiment 4 comprises an enclosure 5 and an access hatch 6. The second embodiment 7 an enclosure framework 8, a covering 9 and an access hatch 10.

In the first embodiment 4, the enclosure 8 surrounds the front 11, outside 12 and rear 13 of the wheels 2 of the commercial vehicle 3 and comprises a front panel 15, side panel 16, top panel 17, and rear panel 18. The enclosure 2 is made of material of sufficient durability to absorb the impact of rubber being thrown from the wheel 2 of the commercial vehicle 3 while the commercial vehicle 3 is moving. The side panel 16 is shaped so that the access hatch 6 can fit into the opening 19 of the side panel 16 and appear as a uniform piece so that the opening 19 comprises an upper edge 20, a lower front edge 21 and a lower rear edge 23. The enclosure 5 may also possess a plurality of reinforcement means 24 on at least one of the front panel 15, side panel 16, top panel 17, and rear panel 18, where the plurality of reinforcement means 24 is made of material of sufficient durability to aid in the structural integrity of the enclosure 5 when said reinforcement means are attached to the at least one of the front panel 15, side panel 16, top panel 17, and rear panel 18.

The access hatch 6 comprises an upper edge 25, a lower forward portion 26 and a lower rear portion 27, and wherein the upper edge 25 of said access hatch 6 is attached to the upper edge 20 of the side panel 16 by a plurality of hinges 28 such that the access hatch 6 folds up to be out of the way and allow access to the wheels 2. The access hatch 6 also comprises a plurality of closing means 29 wherein said plurality of closing means 29 comprise at least one of a latch, clasp, bolt or toggle and appropriate receiver, to assure the access hatch 6 does not open while the commercial vehicle 3 is moving and wherein a first of the plurality of closing means 29 is located on the lower forward portion 26 of the access hatch 6 and secures the access hatch 6 to the lower front edge 21 of the side panel 16 and a second of the plurality of closing means 29 is located on the lower rear portion 27 of the access hatch 6 and secures to the lower rear edge 23 of the side panel 16.

The second embodiment 7 of the wheel protective cover 1 comprises an enclosure framework 8, a covering 9 and an access hatch 10. The enclosure framework 8 creates a structure around the front 11, outside 12 and rear 13 of the wheels 2 of the commercial vehicle 3, and comprises a front structure 30, side structure 31, top structure 32, and rear structure 33. The side structure 31 is shaped so as to have an opening 34 wherein the access hatch 10 can fit into the opening 34 and appear as a uniform piece, wherein the side structure 31 comprises an upper edge 35, a lower front edge 36 and a lower rear edge 37. The enclosure framework 8 is made of material of sufficient durability to absorb the impact of rubber being thrown from the wheel of the commercial vehicle while the vehicle is moving. The enclosure framework 8 may also possess a plurality of reinforcement means 38 on at least one of the front structure 30, side structure 31, top structure 32, and rear structure 33, wherein said reinforcement means 38 is made of material of sufficient durability to aid in the structural integrity of the enclosure structure 8 when said reinforcement means are attached to the at least one of the front structure 30, side structure 31, top structure 32, and rear structure 33.

The access hatch 10 comprises an upper edge 39, a lower forward portion 40 and a lower rear portion 41, and wherein said access hatch 10 is attached to the upper edge 35 of the side structure 30 by a plurality of hinges 24 located along the upper edge 39 of the access hatch 10 such that, when the access hatch 10 is opened, the access hatch 10 folds up to be out of the way so the operator can access the wheels 2. The access hatch 10 also comprises a plurality of closing means 29 wherein said plurality of closing means 29 comprise at least one of a latch, clasp, bolt or toggle and appropriate receiver, to assure the access hatch 10 does not open while the commercial vehicle 3 is moving and wherein a first of the plurality of closing means 29 is located on the lower forward portion 40 of the access hatch 10 and secures the access hatch 10 to the lower front edge 36 of the side structure 31 and a second of the plurality of closing means 29 is located on the lower rear portion 40 of the access hatch 10 and secures to the lower rear edge 37 of the side structure 31.

The covering 9 is attached to the enclosure framework 8 and access hatch 10 by an appropriate attachment means 41, wherein said attachment means is at least one of welds, rivits, bolts, or screws, and wherein the covering 9 is made up of at least one of a sheet metal, cable netting, fiberglass, rubber, aluminum, or durable plastic.

Either the first embodiment 4 or the second embodiment 7 can be attached to a commercial vehicle 3 either directly on the underside 43 of the commercial vehicle 3 or attached to a slider 44 of the commercial vehicle 3 where the slider 44 is the rear axil assembly of the commercial vehicle 3 that can be adjusted to compensate for weight distribution.

What is claimed:

1. A wheel protective cover to prevent the rubber from wheels from being thrown in the event of a blowout while the commercial vehicle is moving comprising:
an enclosure and an access hatch;
the enclosure surrounds the front, outside and rear of the wheels of the commercial vehicle and comprises a front panel, side panel, top panel and rear panel;
the side panel is shaped so that the access hatch can fit into the opening and appear as a uniform piece;
the opening comprises an upper edge, a lower front edge and a lower rear edge;
the enclosure is made of material of sufficient durability to absorb the impact of rubber being thrown from the wheel of the commercial vehicle while the vehicle is moving;
the access hatch is attached to the upper edge of the opening in the side panel by a plurality of hinges located along the upper edge of the access hatch such that, when the panel is opened, the access hatch folds up to be out of the way;
the access hatch also comprises a plurality of closing means to assure the access hatch does not open while the commercial vehicle is moving; and
a first of the plurality of closing means is located on the lower forward portion of the access hatch and secures to the lower front edge of the opening and a second of the plurality of closing means is located on the lower rear portion of the access hatch and secures to the lower rear edge of the opening.

2. The wheel protective cover of claim 1 wherein enclosure is attached to the underside of the commercial vehicle.

3. The wheel protective cover of claim 2 wherein the enclosure also possesses a plurality of reinforcement means on at least one of the front panel, side panel, top panel and rear panel.

4. The wheel protective cover of claim 1 wherein enclosure is attached to a slider of the commercial vehicle.

5. The wheel protective cover of claim 4 wherein the enclosure also possesses a plurality of reinforcement means on at least one of the front panel, side panel, top panel and rear panel.

6. A wheel protective cover to prevent the rubber of the enclosed wheels from being thrown in the event of a blowout while the commercial vehicle is moving comprising:
an enclosure framework, a covering and an access hatch;
the enclosure framework creates a structure around the front, outside and rear of the wheels of the commercial vehicle, and comprises a front structure, side structure, top structure and rear structure;
the side structure is shaped so that the access hatch can fit into the opening and appear as a uniform piece;
the opening comprises an upper edge, a lower front edge and a lower rear edge;
the enclosure framework is made of material of sufficient durability to absorb the impact of rubber being thrown from the wheel of the commercial vehicle while the vehicle is moving;
the access hatch is attached to the upper edge of the opening in the side structure by a plurality of hinges located along the upper edge of the access hatch such that, when the panel is opened, the access hatch folds up to be out of the way;
the access hatch also comprises a plurality of closing means to assure the access hatch does not open while the commercial vehicle is moving; and
a first of the plurality of closing means is located on the lower forward portion of the access hatch and secures to the lower front edge of the opening and a second of the plurality of closing means is located on the lower rear portion of the access hatch and secures to the lower rear edge of the opening.

7. The wheel protective cover of claim 6 wherein the covering goes over the enclosure framework and access hatch.

8. The wheel protective cover of claim 7 wherein the covering is made up of at least one of a sheet metal, cable netting, fiberglass, rubber, aluminum, or durable plastic.

9. The wheel protective cover of claim 8 wherein enclosure is attached to the underside of the commercial vehicle.

10. The wheel protective cover of claim 9 wherein the enclosure also possesses a plurality of reinforcement means on at least one of the front panel, side panel, top panel and rear panel.

11. The wheel protective cover of claim 8 wherein enclosure is attached to a slider of the commercial vehicle.

12. The wheel protective cover of claim 11 wherein the enclosure also possesses a plurality of reinforcement means on at least one of the front panel, side panel, top panel and rear panel.
